(19) United States
(12) Patent Application Publication
(10) Pub. No.: US 2023/0120954 A1
(43) Pub. Date: Apr. 20, 2023

(54) CLEANING MEMBER CONTROL BASED ON INFORMATION DETECTED BY PAPER DETECTION SENSOR

(71) Applicant: HEWLETT-PACKARD DEVELOPMENT COMPANY, L.P., Spring, TX (US)

(72) Inventors: Dong Woo KIM, Seongnam-si (KR); Jung Hyun SHIN, Seongnam-si (KR)

(73) Assignee: HEWLETT-PACKARD DEVELOPMENT COMPANY, L.P., Spring, TX (US)

(21) Appl. No.: 17/907,918

(22) PCT Filed: Jan. 29, 2021
(86) PCT No.: PCT/US2021/015826

§ 371 Date: Aug. 29, 2022

(30) Foreign Application Priority Data
Mar. 6, 2020 (KR) 10-2020-0028299

(51) Int. Cl. G03G 21/16; G03G 21/18; B41J 29/17; B41J 29/393

(52) U.S. Cl. CPC G03G 21/169; G03G 21/1814; G03G 21/1842; B41J 29/17; B41J 29/393; G03G 2215/0062; B41J 2029/3937

(57) ABSTRACT

An image forming apparatus includes a detection sensor to irradiate light to a recording medium passing through a printing path, and detect an amount of light, a driving device to move a cleaning member to a cleaning region overlapping the printing path to clean a light window of the detection sensor, and a processor to confirm a position of the cleaning member based on the amount of light detected by the detection sensor and control the driving device to move the cleaning member based on the confirmed position.

### BACKGROUND

An image forming apparatus refers to an apparatus that prints printing data generated by a printing control terminal apparatus such as a computer on a printing paper. An example of such an image forming apparatus may include a copier, a printer, a facsimile, a multi-function printer (MFP) in which functions of the copier, the printer, and the facsimile are complexly implemented through one apparatus, and the like.

### BRIEF DESCRIPTION OF THE DRAWINGS

FIG. 1 is a block diagram illustrating an example of a schematic configuration of an image forming apparatus;

FIG. 2 is a block diagram illustrating an example of a detailed configuration of the image forming apparatus;

FIG. 3 is a schematic configuration diagram for describing a disposition example of a paper detection sensor of FIG. 1;

FIG. 4 is a conceptual diagram for describing a configuration example of an optical sensor;

FIG. 5 is a view for describing an example of a moving path of a cleaning member of FIG. 1;

FIGS. 6A and 6B are views illustrating an example of a detected value of the paper detection sensor in a moving process of the cleaning member;

FIG. 7 is a view for describing a movement control method of the cleaning member based on a detected value in FIG. 6B; and

FIG. 8 is a flowchart illustrating an image forming method according to an example.

### DETAILED DESCRIPTION

Hereinafter, various examples will be described in detail with reference to the drawings. Examples to be described later may be modified into several different forms. To more clearly describe features of examples, a detailed description for contents well-known to those skilled in the art to which the following examples belong will be omitted.

Meanwhile, when any component is referred to as being “connected to” another component in the present specification, it means that any component and another component are “directly connected to” each other or are “connected to” each other with another component or components interposed therebetween. In addition, when any component is referred to as “including” another component, it means the inclusion of other components rather than the exclusion of other components, unless explicitly described to the contrary.

In the present specification, an “image forming job” may refer to various jobs (for example, printing, scanning, or faxing) related to an image, such as forming of the image, generating/storing/transmitting of an image file, or the like, and a “job” may refer to the image forming job, but may also include a series of processes for performing the image forming job.

In addition, an “image forming apparatus” may refer to an apparatus that prints printing data generated in a terminal apparatus such as a computer on a recording paper. An example of such an image forming apparatus may include a copier, a printer, a facsimile, a multi-function printer (MFP) in which functions of the copier, the printer, and the facsimile are complexly implemented through one apparatus, or the like.

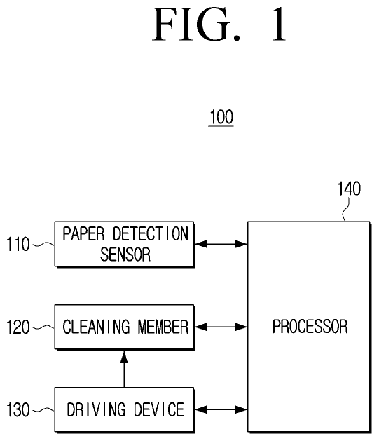

FIG. 1 is a block diagram illustrating an example of a schematic configuration of an image forming apparatus.

Referring to FIG. 1, an image forming apparatus 100 may include a paper detection sensor 110, a cleaning member 120, a driving device 130, and a processor 140.

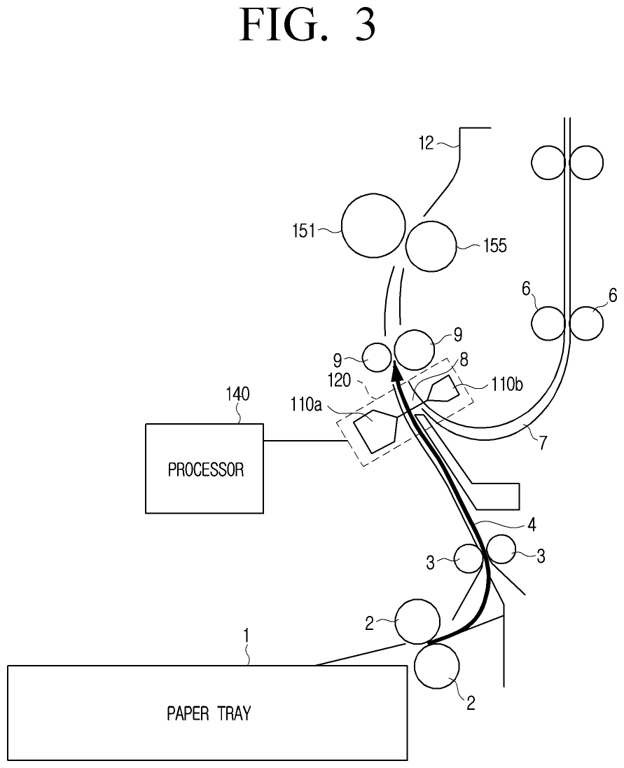

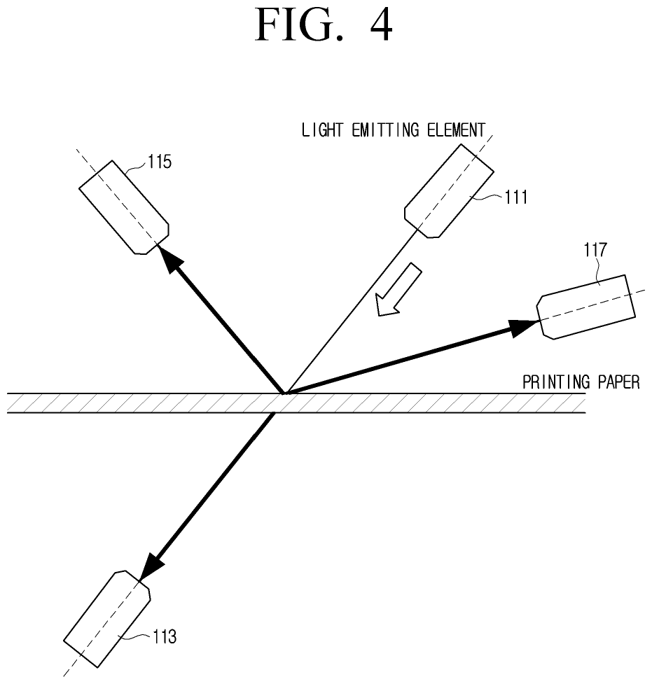

The paper detection sensor 110 may irradiate light to a printing paper and detect an amount of light. Such a paper detection sensor 110 may be an optical media sensor, and may output an analog signal having a voltage magnitude corresponding to a detected amount of transmitted light. A detailed configuration and operation of the paper detection sensor 110 will be described later with reference to FIGS. 3 and 4.

The cleaning member 120 cleans the paper detection sensor 110. For example, the cleaning member 120 may sequentially move onto a home region, a first moving region, a cleaning region, and a second moving region, and one surface or both surfaces of the cleaning member 120 may clean a light window of the paper detection sensor 110 by coming into contact with the light window of the paper detection sensor 110 when the cleaning member 120 moves onto the cleaning region.

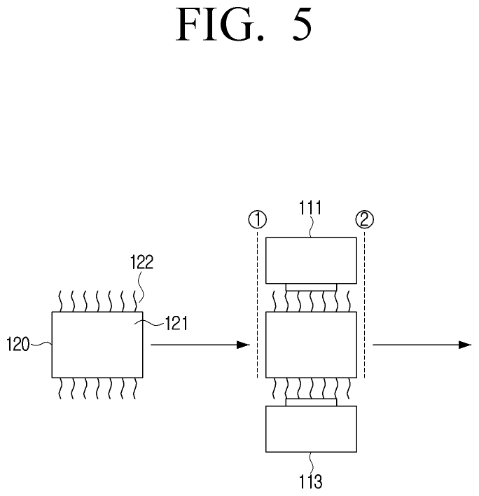

Here, the light window refers to a transparent window in front of a light emitting element of the paper detection sensor 110 emitting light or a transparent window in front of a light receiving sensor of the paper detection sensor 110 receiving the light. A detailed configuration and operation of the cleaning member 120 will be described later with reference to FIG. 5.

The driving device 130 moves the cleaning member 120. For example, the driving device 130 may include a motor such as a direct current (DC) motor, a step motor, or a linear motor, a gear, and the like, and may allow the cleaning member to move on a cleaning path according to a control command of the processor 140.

The processor 140 controls a general operation of the image forming apparatus 100. For example, the processor 140 may generally control an operation of the image forming apparatus 100 by executing at least one instruction stored in a memory 170 to be described later. Such a processor 140 may be implemented by a central processing unit (CPU), an application specific integrated circuit (ASIC), or the like.

The processor 140 may determine whether or not thickness detection of the printing paper needs to be performed. For example, when a paper tray is opened or closed or a new printing job is received, the processor 140 may determine that the thickness detection needs to be performed. Meanwhile, at the time of implementation, the processor 140 may perform the thickness detection on all of the printing papers picked up for each printing page.

The processor 140 may control the paper detection sensor 110 to irradiate the light to the printing paper and detect an amount of transmitted light in the irradiated light when paper determination needs to be performed. When a voltage value corresponding to the amount of transmitted light is output from the paper detection sensor 110, the processor 140 may obtain a magnitude of the voltage value output from the paper detection sensor 110 using an analog digital converter (ADC) terminal in the processor 140. Here, the obtained magnitude of the voltage value may be information on the amount of transmitted light.

In addition, the processor 140 may control a printing engine 150 to perform a printing job on the basis of the determined thickness. For example, the processor 140 may perform the printing job by adjusting a printing speed, a fixing state, and/or a developing state on the basis of the determined thickness of the printing paper.

The processor 140 may determine whether or not a cleaning operation needs to be performed. For example, the processor 140 may control the paper detection sensor 110 to irradiate a set amount of light, and determine that the cleaning operation needs to be performed in a case where the amount of light detected by the paper detection sensor 110 is less than a set value.

As an example, the processor 140 may determine that the cleaning operation needs to be performed on the basis of the number of accumulated printed papers. For example, in a case where the cleaning operation needs to be performed in units of hundred papers, the processor 140 may count the number of printed papers, and determine that the cleaning operation needs to be performed in a case where the counted number of printed papers arrives at a set value such as hundred papers, two hundred papers, three hundred papers, or the like.

It has been described hereinabove that the cleaning operation is performed in a case of arriving at a specific condition, but the cleaning operation may also be performed in a process of booting the imaging forming apparatus 100, before a printing job is performed, in a case where an event such as an opening or closing event of a paper tray, an opening or closing event of a front or side cover, or the like, occurs regardless of the arrival of the specific condition at the time of implementation.

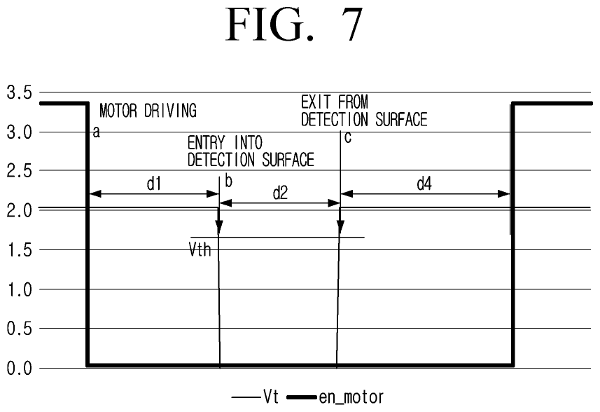

The processor 140 may control the driving device 130 to perform the cleaning operation in a case where the cleaning operation needs to be performed. In this case, the processor 140 may confirm a position of the cleaning member 120 based on the amount of light detected by the paper detection sensor 110, and control the driving device 130 based on the confirmed position. A specific cleaning control operation of the processor 140 will be described later with reference to FIG. 7.

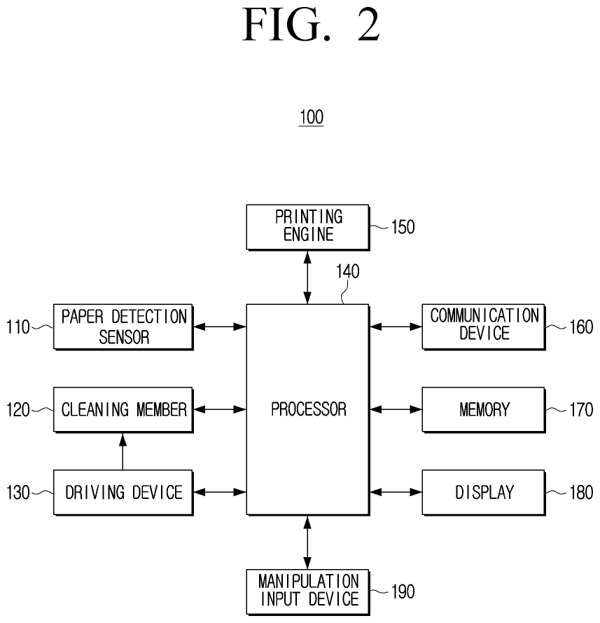

Simple components of the image forming apparatus are illustrated and described hereinabove, but various components may be further included in the image forming apparatus at the time of implementation. These components will be described below with reference to FIG. 2.

FIG. 2 is a block diagram illustrating an example of a detailed configuration of the image forming apparatus.

Referring to FIG. 2, the image forming apparatus 100 according to an example includes the paper detection sensor 110, the cleaning member 120, the driving device 130, the processor 140, a printing engine 150, a communication device 160, a memory 170, a display 180, and a manipulation input device 190.

The paper detection sensor 110, the cleaning member 120, and the driving device 130 perform the same functions as those of the components of FIG. 1, and an overlapping description is thus omitted.

The printing engine 150 may form an image on a printing paper. Such a printing engine 150 may form an image in an inkjet manner or may form an image an electrophotographic manner.

Here, the printing paper may be referred to as a recording medium, a paper, or the like, and may be a paper, but may also be a label paper, a coated paper, and an overhead projector (OHP) film, or the like.

In addition, the printing engine 150 may perform a printing job at a printing speed and under a transfer condition and a fixing condition that correspond to the thickness of the printing paper determined by the processor 140.

For example, in a case where it is determined that a paper thicker than a general paper is used, the printing engine 150 may perform a transfer operation using a transfer voltage higher than a reference transfer voltage or may perform fixing at a fixing temperature higher than a reference fixing temperature. In this case, the printing engine 150 may perform the printing job at a speed slower than a reference printing speed.

The communication device 160 may be formed in order to connect the image forming apparatus 100 to an external device, and may be connected through a local area network (LAN) and an Internet network, but may also be connected through a universal serial bus (USB) port and a wireless module. Here, the wireless module may be WiFi, WiFi Direct, near field communication (NFC), Bluetooth, or the like.

In addition, when occurrence of an error is confirmed, the communication device 160 may transmit information on the confirmed error to a user terminal apparatus and/or a management server.

The memory 170 may store at least one instruction regarding the image forming apparatus 100. For example, various programs (or machine readable instructions) for operating the image forming apparatus 100 according to various examples may be stored in the memory 170.

The memory 170 may store printing data received through the communication device 160. Such a memory 170 may be implemented by a storage medium in the image forming apparatus 100 and an external storage medium, for example, a removable disk including a universal serial bus (USB) memory, a storage medium connected to a host, a web server through a network, or the like.

The display 180 may display various information provided by the image forming apparatus 100. For example, the display 180 may display a user interface window for receiving a user's selection for various functions provided by the image forming apparatus 100. Such a display 180 may be a monitor such as a liquid crystal display (LCD), a cathode ray tube (CRT), or organic light emitting diodes (OLED), and may be implemented by a touch screen capable of simultaneously performing a function of a manipulation input device 190 to be described later.

In addition, the display 180 may display a control menu for performing a function of the image forming apparatus 100. In addition, when an error occurs, the display 180 may display an error occurrence fact, an error type, and the like.

The manipulation input device 190 may receive a function selection and a control command for the function, input from a user. Here, the function may include a printing function, a copying function, a scanning function, and a fax transmission function. The control command for such a function may be input through the control menu displayed on the display 180.

Such a manipulation input device 190 may be implemented by a plurality of buttons, a keyboard, a mouse, or the like, and may also be implemented by a touch screen capable of simultaneously performing the function of the display 180 described above.

The processor 140 may determine whether or not the cleaning operation needs to be performed before the printing job when the printing data is received through the communication device 160. When the cleaning operation needs to be performed, the processor 140 may control the driving device 130 to perform the cleaning operation, and may control the printing engine 150 to perform the printing job after the cleaning operation.

In addition, the processor 140 may confirm whether or not the cleaning member is positioned in the cleaning region before the printing job, and may control the display 180 to display an error message when it is confirmed that the cleaning member is positioned in the cleaning region.

As described above, the image forming apparatus 100 according to the present example may determine a position of the cleaning member using the amount of light detected by the paper detection sensor, and control movement of the cleaning member using the determined position.

Meanwhile, in illustrating and describing FIGS. 1 and 2, it has been illustrated and described that the paper detection sensor 110, the cleaning member 120, and the driving device 130 are separate devices and components separated from the printing engine 150, but the paper detection sensor 110, the cleaning member 120, and the like may be components in the printing engine 150 at the time of implementation.

In addition, in illustrating and describing FIGS. 1 and 2, it has been illustrated and described that the cleaning member 120 and the driving device 130 are different components, but the cleaning member 120 and the driving device 130 may be implemented as one device. In addition, the paper detection sensor 110, the cleaning member 120 and the driving device 130 may be implemented as a single module at the time of implementation.

FIG. 3 is a schematic configuration diagram for describing a disposition example of a paper detection sensor of FIG. 1.

Referring to FIG. 3, a paper transport device may transport a printing paper on a paper transport path using a plurality of rollers 2, 3, 6, 9 and the like.

A paper tray 1 may accommodate the printing paper (a medium forming a toner image on a surface thereof).

Pick-up rollers 2 may pick up the printing paper accommodated in the paper tray 1. In addition, feed rollers 3 may move the printing paper picked up by the pick-up rollers 2 to a paper transport path 4.

The paper detection sensor may be disposed between the paper tray 1 and registration rollers 9. Such a paper detection sensor may include optical sensors 110a and 110b called optical media sensors. The optical sensors 110a and 110b may detect a thickness of the printing paper transported on the paper transport path 4. A detailed configuration of the optical sensor will be described later with reference to FIG. 4.

Back-side conveyance path rollers 6 may transport the printing paper whose one surface is subjected to printing, along a conveyance path 7 at the time of double-sided printing.

The paper transport path 4 and the conveyance path 7 join at a joining point 8, and the printing paper transported by the feed rollers 3 or the printing paper conveyed by the back-side conveyance path rollers 6 may pass through the joining point 8. Meanwhile, in a case where the image forming apparatus 100 supports single-sided printing but not double-sided printing, the back-side conveyance path rollers 6 and the conveyance path 7 described above may be omitted.

The registration roller 9 may supply the printing paper that has passed through the joining point 8 to transfer devices 151 and 155 under the control of the processor. Such registration rollers 9 may be rollers for aligning skew of the transported paper.

The image forming conveyance portion 12 may discharge the printing paper whose one surface is subjected to the printing to the outside or provide the printing paper whose one surface is subjected to the printing to the conveyance path 7 in a case of the double-sided printing.

Hereinafter, a control operation of the processor 140 of FIGS. 1 and 2 will be described using the components described above.

When the printing data is received, the processor 140 may parse the received printing data to generate binary data, and perform a printing job using the generated binary data.

In addition, the processor 140 may control the pickup rollers 2 to pick up the printing paper. The printing paper may be picked up by such an operation and enter the paper transport path by the feed rollers 3.

In this case, the processor 140 may acquire a voltage value output from light receiving sensors constituting the optical sensors 110a and 110b, and determine a type of the printing paper that is being transported, on the basis of the voltage value.

When the type of the printing paper is determined, the processor may select appropriate printing conditions such as a conveyance speed, a transfer condition, a fixing condition, and the like, of the printing paper, and pass the printing paper through the transfer devices 151 and 155 using the registration rollers 9 when preparation of a printing job using the corresponding conditions is completed.

The processor 140 may determine whether or not cleaning of the optical sensors 110a and 110b needs to be performed before the printing operation ends or a printing operation, and may perform a cleaning operation for the optical sensors 110a and 110b when the cleaning of the optical sensors 110a and 110b needs to be performed.

FIG. 4 is a conceptual diagram for describing a configuration example of an optical sensor.

Referring to FIG. 4, the optical sensor may include a light emitting element 111 and a plurality of light receiving sensors 113, 115 and 117.

The light emitting element 111 may be an optical component such as a light emitting diode (LED) emitting light, and may be configured by a light emitting element itself or may be configured by a plurality of optical components. A light window may be disposed in front of the light emitting element 111, and light may be irradiated through the light window.

A transmitted light receiving sensor 113 may be installed substantially in line with an optical path of the light emitted from the light emitting element 111, and may detect an amount of transmitted light, which is an amount of light transmitted through the printing paper in the light emitted from the light emitting element 111.

A specularly reflected light receiving sensor 115 may be installed at a position at which it may detect an amount of specularly reflected light, which is an amount of light specularly reflected by the printing paper in the light emitted from the light emitting element 111.

A diffusely reflected light receiving sensor 117 may be installed at a position at which it may detect an amount of diffusely reflected light, which is an amount of light diffusely reflected by the printing paper in the light emitted from the light emitting element 111.

Light windows may be disposed in front of the light receiving sensors 113, 115, and 117 described above, and magnitudes of the received light may be detected through the light windows. Meanwhile, it has been described hereinabove that the light windows are disposed in front of the optical components and the like, but in a case where the optical components are directly exposed to the outside at the time of implementation, surfaces of the optical components may operate as the light windows.

The transmitted light receiving sensor 113, the specularly reflected light receiving sensor 115, and the diffusely reflected light receiving sensor 117 may use, for example, a photodiode (PD) or a phototransistor (PTr).

In addition, the amount of transmitted light, the amount of specularly reflected light, and the amount of diffusely reflected light described above may be treated as voltage values output by the respective light receiving sensors, respectively. Hereinafter, in order to facilitate a description, it will be described to determine a position of the cleaning member using the amount of transmitted light detected by the transmitted light receiving sensor 113. At the time of implementation, it is also possible to additionally refer to the amount of specularly reflected light or the amount of diffusely reflected light or to use the amount of specularly reflected light or the amount of diffusely reflected light.

Since the optical sensor uses the amount of light as described above, in a case where the amount of light changes due to a factor other than the printing paper, an error may occur in determining a thickness or a type of the printing paper.

As described above, a change in the amount of light may occur due to contamination, and it is thus necessary to periodically clean the light window described above. To this end, in the present disclosure, the light window described above may be cleaned using the cleaning member. A detailed configuration and operation of the cleaning member will be described below.

FIG. 5 is a view for describing a moving path of the cleaning member of FIG. 1.

Referring to FIG. 5, the cleaning member 120 may sequentially move onto a home region, a first moving region, a cleaning region (section between 1 and 2), and a second moving region.

The home region is a region where the cleaning member is positioned in a case where the cleaning operation is not performed, and is a position spaced apart from a printing path on which the printing paper moves.

The cleaning region is a region where the cleaning member is positioned at the time of the cleaning operation, is a region between the light emitting element 111 and the light receiving sensor 113, and is a position overlapping the printing path.

The first moving region is a region between the home region and the cleaning region, and the second moving region is a right region of the cleaning region and is a region where the cleaning member 120 is positioned when a direction of the cleaning member 120 changes from a first direction (direction from the home region toward the cleaning region) into a second direction opposite to the first direction.

Materials such as villus may be disposed on both sides of the cleaning member 120. Therefore, in a case where the cleaning member 120 enters the cleaning region, one side of the cleaning member 120 may come into contact with the light window of the light emitting element 111 and/or the light receiving sensor 113 of the paper detection sensor to clean the light window.

The cleaning member 120 may perform the cleaning operation through reciprocation in which the cleaning member 120 moves onto the home region, the first moving region, the cleaning region, and the second moving region, and then moves again onto the cleaning region, the first moving region, and the home region according to the control of the driving device 130.

Meanwhile, at the time of implementation, the cleaning member 120 may not reciprocate, but may also move in one way. That is, the home region is disposed at each of both ends of a path through which the cleaning member 120 moves, so that the cleaning member 120 may perform one-way movement at a time in a cleaning process.

Meanwhile, the reciprocation of the cleaning member may be implemented by changing a rotation direction of a motor or may be implemented by using a combination of a motor rotatable in one direction and a spring member.

For example, at the time of moving the cleaning member in the first direction, the cleaning member may be moved by operating the motor, and at the time of moving the cleaning member in the second direction, the drive of the motor may be stopped and a restoring force of a spring acting in the second direction may be used.

Hereinafter, an operation of the paper detection sensor in a case where the cleaning member reciprocates as described above will be described.

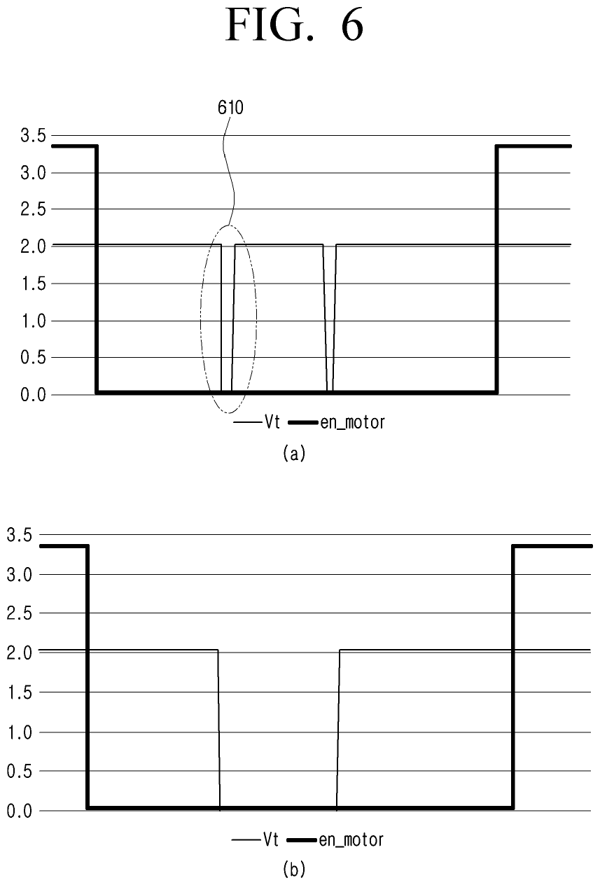

FIGS. 6A and 6B are views illustrating an example of a detected value of the paper detection sensor in a moving process of the cleaning member.

For example, FIG. 6A is a waveform diagram illustrating a motor driving signal en_motor and a value Vt detected by the paper detection sensor in a cleaning process.

Here, the motor driving signal en_motor is a signal indicating a preparation state of the motor. For example, in a case where the motor driving signal has a high value, it indicates a state where the cleaning member may not move, and in a case where the motor driving signal has a low value, it indicates a state where the cleaning member may move according to a control command.

In addition, the detected value Vt indicates a voltage value detected by the transmitted light receiving sensor 113 illustrated in FIG. 4 in the paper detection sensor. For example, in a case where the detected value has a high value, it may indicate that an object (for example, the printing paper or the cleaning member) is not positioned in a detection region of the paper detection sensor, and in a case where the detected value has a low value, it may indicate that an object is positioned in the detection region of the paper detection sensor.

Referring to FIG. 6A, when the motor for moving the cleaning member is driven, the cleaning member is moved in the first direction (direction from the home region toward the cleaning region). At this point in time, the cleaning member is positioned in the home region or the first moving region, and the signal value Vt detected by the paper detection sensor may thus be a high value.

When the cleaning member continuously moves in the first direction to enter the cleaning region, the detected value by the paper detection sensor 110 changes from the high value to a low value.

When the cleaning member enters the cleaning region, the cleaning member cleans the paper detection sensor. Subsequently, when the cleaning member continuously moves in the first direction to exit from the cleaning region, an optical path between the light emitting element and the light receiving element is returned, and the detected value by the paper detection sensor changes to a high value.

As described above, during a process in which the cleaning member passes through the cleaning region, as in a region 610, an output value of the paper detection sensor is converted from the high value to the low value, and is converted again from the low value to the high value.

In consideration of this, the processor may determine that the cleaning member has entered the cleaning region when the signal value output from the paper detection sensor changes from the high value to the low value. Conversely, the processor may determine that the cleaning member exits from the cleaning region when the signal value output from the paper detection sensor changes from the low value to the high value.

In addition, when the cleaning member passes through the cleaning region, a moving direction of the cleaning region may change for reciprocation. The change in the direction may be performed by changing a rotation direction of the motor, and in a case of using an elastic member such as a spring, the change in the direction may be performed by cutting off a rotational force of the motor.

When the moving direction is changed, the cleaning member passes through the cleaning region for the second time. Therefore, the output value from the paper detection sensor may transition from the high value to the low value and then switch again from the low value to the high value.

It has been described hereinabove that the paper detection sensor outputs the high value when the cleaning member enters the second moving region, but in a case where the cleaning member is moved using a lever disposed on a side of the cleaning member, the output value of the paper detection sensor may be maintained in the low value even in the second moving region. Such an example will be described below.

FIG. 6B is waveform diagrams in a case where a lever moving the cleaning member is implemented in a form in which it is detected by the paper detection sensor.

Referring to FIG. 6B, it may be confirmed that the paper detection sensor continuously outputs a low value from after the cleaning member enters the cleaning region until the cleaning member changes a direction and exits from the cleaning region.

In a case where the lever is disposed on one side of the cleaning member as described above, it is possible to detect entry and exit of the cleaning member in one direction, but it is difficult to detect entry and exit of the cleaning member in an opposite direction.

Therefore, in the present disclosure, entry and exit points in time of the cleaning member in the opposite directions described above may be predicted on the basis of a length of the cleaning region and a moving speed of the cleaning member, and the movement of the cleaning member may be controlled using the predicted points in time. This will be described below with reference to FIG. 7.

FIG. 7 is a view for describing a movement control method of the cleaning member based on a detected value in FIG. 6B.

Referring to FIG. 7, when the cleaning operation needs to be performed (a), the processor may control the driving device to move the cleaning member in the first direction. The driving device to which a control command is input may drive the motor to move the cleaning member 120 in the first direction (for example, the direction from the home region toward the cleaning region). In this case, the processor may control the driving device to move the cleaning member at a constant speed.

In addition, after entry of the cleaning member (b), the processor 140 may control the cleaning device to continuously move in the first direction for a set time. Here, the set time may be a time value obtained by dividing the length of the cleaning region by a driving speed or a value obtained by adding a predetermined value to the time value as represented by the following Equation 1:

Motor (stepping) control step=L/moving distance per motor step. [Equation 1]

Here, L is the length of the cleaning region.

When the set time elapses, the processor may control the driving device to move the cleaning member in the second direction. For example, in a case where the cleaning member is moved in the second direction with the restoring force of the spring, the processor may control the driving device so that a driving force of the motor is not supplied to the cleaning member.

Meanwhile, in a case where the cleaning member is moved in the second direction by driving of the motor, the processor may control the driving device to move the cleaning member in the second direction, and control the driving device to maintain the movement of the cleaning member in the second direction for a set second time (that is, a time for the cleaning member to move by a length of the first moving region) (d4) when it is confirmed that the cleaning member exits from the cleaning region.

Meanwhile, in a case where the position of the cleaning member may not be obtained, such that the cleaning member is positioned in the cleaning region during a printing job, the cleaning member is disposed on the paper transport path, such that a jam may occur or damage to a component may occur.

Therefore, the position of the cleaning member is to be detected to control the cleaning member. To this end, the processor may detect an error regarding the movement of the cleaning member using the signal detected by the paper detection sensor.

For example, since a distance between the home region and the cleaning region (that is, the length of the first moving region) is equal to d1, the processor may confirm whether or not an error has occurred when the cleaning member moves in the first direction depending on whether or not the output value of the paper detection sensor has changed within a time corresponding to the distance of d1.

In addition, the processor may confirm whether or not there is no error in the movement of the cleaning member depending on whether or not the cleaning member enters the first movement region within a set time after the direction change. In addition, in a case of outputting the waveform diagrams as illustrated in FIG. 6A, the processor may confirm a movement error by confirming whether or not a movement (d2/2) of the cleaning member in the cleaning period is performed within a set time.

In addition, the processor may confirm whether or not the cleaning member or another foreign material or the like is positioned in the cleaning region by confirming the output value of the paper detection sensor before the printing job as well as in the moving process of the cleaning member.

As described above, the image forming apparatus according to the present example obtains the position of the cleaning member using the paper detection sensor without using a separate detection sensor. Therefore, the damage to the component and the occurrence of the jam may be prevented, and a manufacturing cost may be reduced.

Meanwhile, in illustrating and describing FIGS. 6 and 7, it has been illustrated and described that the paper detection sensor outputs the low value in a case where the printing paper (or the cleaning member) is detected and outputs the high value in a case where the printing paper (or the cleaning member) is not detected, but these two values may be opposite to each other at the time of implementation. That is, the paper detection sensor may output the high value when the printing paper is detected and output the low value when the printing paper is not detected.

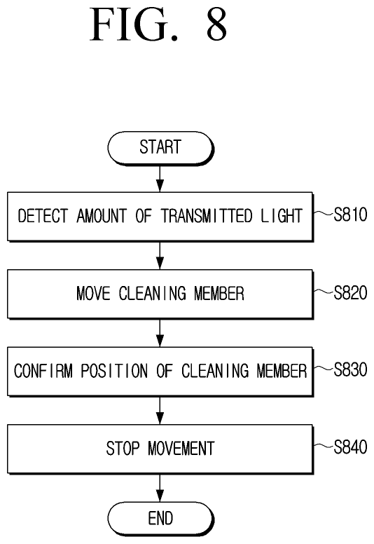

FIG. 8 is a flowchart illustrating an image forming method according to an example.

Referring to FIG. 8, the amount of light may be detected by the paper detection sensor (S810). For example, the amount of light may be detected using the transmitted light receiving sensor of the paper detection sensor.

Then, the cleaning member may be moved in the first direction (S820). Meanwhile, it has been described in FIG. 8 to move the cleaning member after performing the detecting of the amount of light, but at the time of implementation, the detecting operation may be performed after the moving operation or the detecting operation and the moving operation may be simultaneously performed continuously.

Then, the position of the cleaning member cleaning the paper detection sensor is confirmed on the basis of the detected amount of light (S830). For example, when the amount of light detected by the paper detection sensor changes from the high level to the low level, it may be determined that the cleaning member has entered the cleaning region, and when the amount of light detected by the paper detection sensor changes from the low level to the high level, it may be determined that the cleaning member exits from the cleaning region.

In addition, the movement of the cleaning member may be controlled on the basis of the confirmed position. For example, when it is confirmed that the cleaning member has exited from the cleaning region for the first time, the moving direction of the cleaning member may change after a set time, and when the cleaning member is confirmed that the cleaning member has exited from the cleaning region for the second time, the movement of the cleaning member may be controlled so that the cleaning member is moved at a constant speed in the second direction for a set time and the movement of the cleaning member is stopped (S840).

Meanwhile, at the time of implementation, it may be confirmed whether or not an error has occurred in the moving process by confirming whether or not the cleaning member has entered the cleaning region within a time.

Therefore, in an image forming method according to the present example, the position of the cleaning member is obtained using the paper detection sensor without using a separate detection sensor. Therefore, the damage to the component and the occurrence of the jam that may occur because the cleaning member is positioned in a wrong position may be prevented, and a configuration cost may be reduced.

In addition, the image forming method as described above may be implemented by at least one execution program for executing the image forming method as described above, and such an execution program may be stored and provided in a non-transitory computer readable medium.

Although the examples have been illustrated and described hereinabove, the present disclosure is not limited to the specific examples described above, but may be variously modified by those skilled in the art to which the present disclosure pertains without departing from the spirit and scope of the present disclosure claimed in the claims. These modifications are to fall within the scope of the present disclosure.

1. An image forming apparatus comprising:
a detection sensor to irradiate light to a recording medium, and detect an amount of light;
a processor to confirm a position of a cleaning member with respect to a plurality of regions based on the amount of light detected by the detection sensor, the cleaning member being moveable to the plurality of regions based on the confirmed position; and
a driving device to move the cleaning member to a cleaning region among the plurality of regions to clean a light window of the detection sensor.

2. The image forming apparatus as claimed in claim 1, wherein the cleaning member is to sequentially move onto the plurality of regions including a home region, a first moving region, the cleaning region, and a second moving region.

3. The image forming apparatus as claimed in claim 2, wherein the cleaning region is a position overlapping a printing path on which the recording medium is to move, and
the home region is a position spaced apart from the printing path.

4. The image forming apparatus as claimed in claim 2, wherein the processor is to determine that the cleaning member has entered or exited from the cleaning region based on a change in the amount of light detected by the detection sensor.

5. The image forming apparatus as claimed in claim 2, wherein the processor is to control the driving device to move the cleaning member at a constant speed during a set time when it is determined that the cleaning member has entered the cleaning region, and to stop moving the cleaning member after the set time.

6. The image forming apparatus as claimed in claim 5, wherein the set time is a value obtained by dividing a length of the cleaning region by a moving speed of the cleaning member.

7. The image forming apparatus as claimed in claim 2, wherein the processor is to determine whether an error has occurred based on whether the cleaning member has entered the cleaning region within a set time, after controlling the driving device to move the cleaning member.

8. The image forming apparatus as claimed in claim 1, wherein the processor is to
control the driving device to move the cleaning member in a first direction when it is determined to perform cleaning of the detection sensor,
control the driving device to move the cleaning member in a second direction opposite to the first direction when the amount of light detected by the detection sensor is converted from a low level into a high level a first time, and
control the driving device to stop moving the cleaning member when the amount of light detected by the detection sensor is converted from the low level into the high level a second time, the second time occurring after the first time.

9. The image forming apparatus as claimed in claim 1, wherein the processor is to determine whether to perform a cleaning operation of the detection sensor and control the driving device when it is determined to perform the cleaning operation.

10. The image forming apparatus as claimed in claim 9, wherein the processor is to determine to perform the cleaning operation when the amount of light detected by the detection sensor is equal to or less than a set level or a number of accumulated recording medium is equal to a set number of recording medium.

11. The image forming apparatus as claimed in claim 1, wherein the detection sensor includes:
a light emitting element to irradiate light; and
a first light receiving sensor to detect an amount of transmitted light transmitted through the recording medium in the light irradiated from the light emitting element, and
the cleaning member is to clean at least one of a light window of the light emitting element or a light window of the first light receiving sensor.

12. The image forming apparatus as claimed in claim 11, wherein the detection sensor includes:
a second light receiving sensor to detect an amount of reflected light specularly reflected by the recording medium in the light irradiated from the light emitting element; and
a third light receiving sensor to detect an amount of reflected light diffusely reflected by the recording medium in the light irradiated from the light emitting element, and
the cleaning member is to clean at least one of a light window of the second light receiving sensor or a light window of the third light receiving sensor.

13. An image forming method of an image forming apparatus, comprising:
detecting an amount of light using a recording medium detection sensor;
confirming a position of a cleaning member to clean the recording medium detection sensor based on the detected amount of light; and
controlling a driving device, based on the confirmed position of the cleaning member, to move the cleaning member.

14. The image forming method as claimed in claim 13, wherein in the confirming of the position,
when the detected amount of light changes from a high level into a low level, determining that the cleaning member has entered a cleaning region, and
when the detected amount of light changes from the low level into the high level, determining that the cleaning member has exited from the cleaning region.

15. The image forming method as claimed in claim 13 further comprising determining whether a cleaning operation is abnormal based on whether the cleaning member has entered a cleaning region within a set time.
